(19) United States
(12) Patent Application Publication
(10) Pub. No.: US 2010/0253477 A1
(43) Pub. Date: Oct. 7, 2010

(54) RFID READING DEVICE AND A METHOD IN AN RFID READING DEVICE

(76) Inventors: Heikki Seppä, Espoo (FI); Pekka Pursula, Espoo (FI)

Correspondence Address: BIRCH STEWART KOLASCH & BIRCH, PO BOX 747, FALLS CHURCH, VA, 22040-0747, US

(21) Appl. No.: 12/746,789

(22) PCT Filed: Dec. 17, 2008
(86) PCT No.: PCT/FI08/50754

§ 371 Date: Jun. 8, 2010

(30) Foreign Application Priority Data
Dec. 20, 2007 (FI) 20075942

(51) Int. Cl. H04Q 5/22

(52) U.S. Cl. 340/10.1

(57) ABSTRACT

The invention relates to an RFID reader and method for it. The reader comprises a transmitter portion, a receiver portion, and an antenna or antenna group connected to them. According to the invention, the transmitter portion comprises a reactive power divider, in which there are at least two reactive branches (Lₐ, Lᵣ), one branch for feeding the signal to the antenna and a second branch for a variable resistor.

The present invention relates to an RFID reader according to the preamble of claim 1.

The invention also relates to a method in connection with an RFID reader.

Due mainly to logistics applications, the use of RFID is rapidly becoming widespread. The growth of UHF-range RFID has been particularly strong. There are already several readers on the market, but they are relatively expensive and handheld readers are not yet generally available. Traditionally made RFID readers are relatively complex and are unable to take care of the problems caused by powerful reflection and their power consumption is large. A traditional high-frequency RFID reader is based on feeding power from a 50-Ohm power amplifier through a circulation element to a 50-Ohm antenna and through it to the environment. The reflected power is led through the circulation element to a preamplifier.

The present invention is intended to eliminate the problems of the prior art and create an entirely new type of system and method.

The invention is based on using a low-impedance amplifier, a reactive power divider, and an adjustable antenna in the circuit.

In one preferred embodiment of the invention, the transmitter part comprises a transformer, typically a current transformer, in which there are at least three coils, which are connected to the same magnetic field, the antenna or antenna group being fed through the first of which coils, and a reference load being connected to the second coil to compensate for the effect of the transmitted power in the first coil, and the third coil of the transformer being connected to the main amplifier of the receiver.

More specifically, the RFID reader according to the invention is characterized by what is stated in the characterizing portion of claim 1.

The method according to the invention is, for its part, characterized by what is stated in the characterizing portion of claim 9.

Considerable advantages are gained with the aid of various embodiments of the invention.

Adjustable Narrowband Antenna:

In certain embodiments of the invention, the solution attenuates the distortion created by transmission and eliminates the need for separate transmission filtering. GSM or a second RFID transmitter will not interfere with the preamplifier as much as in connection with a broadband antenna. If the antenna were to be made to cover the entire RFID-UHF band in different parts of the world, the antenna would also receive the different GSM frequencies of all parts of the world. A narrowband antenna permits the preamplifier to be connected directly through the transformer to the antenna. An adjustable LC filter placed after the preamplifier will improve the solution.

Power Saving:

Because the power is connected to the antenna through a reactive impedance, the efficiency of the output stage is, in principle, very high. On account of the transformer, in certain embodiments of the invention the power required for compensation is much less than the power going to the antenna.

Certain embodiments of the invention compensate for reflection in a simple manner. Because the antenna is adjustable and narrowband, it is enough to compensate for only the connection of the real component (effective-power-conducting) to the preamplifier. Thus, all the information for compensation is obtained from the output of the demodulator, which in any event is required for reading the code.

A good signal-noise ratio is achieved by means of certain embodiments of the invention. If the power going to the preamplifier is compensated, for example, by synthesizing a response signal, such a solution will often increase noise. This is because the power fed to the antenna and the signal made for compensation do not fully correlate. Because in the case according to the invention the compensation signal is taken from the output of the output stage, which also feeds the signal to the antenna, by using the solution we do not increase noise to the preamplifier.

Certain embodiments of the invention are suitable for all power levels, for a fixed base station, or a portable reader. Different UHF frequencies can be used, but of course, the same solution can also be applied to other frequencies.

By means of the solution according to the invention, an RFID reader can be advantageously integrated in, for example, in a mobile station. A reader according to the invention can be utilized in fixed base stations, in handheld readers operating at a fixed or variable power level, or by combining the method with a GSM telephone. The advantages of the method are emphasized particularly if this method is combined as part of a GSM telephone, because practically no additional cost is incurred by RFID.

The power consumption of an apparatus, such as a mobile telephone, can be reduced, and the operating times in battery-powered devices lengthened significantly. The antenna can also be made with higher efficiency, thus also reducing power consumption. A narrowband antenna should generally be made tunable to avoid problems. Thanks to the narrowband character of the antenna, in the best case expensive bandpass filters can be eliminated, which will reduce the manufacturing costs of especially mobile stations. By means of the solution according to the invention, in the best case the radio-frequency part of an entire mobile telephone can be integrated in the immediate vicinity of the antenna, possibly inside it. The invention can also be used for the noise optimization of the receiver side.

In the following, the invention is examined with the aid of examples of applications according to the accompanying figures.

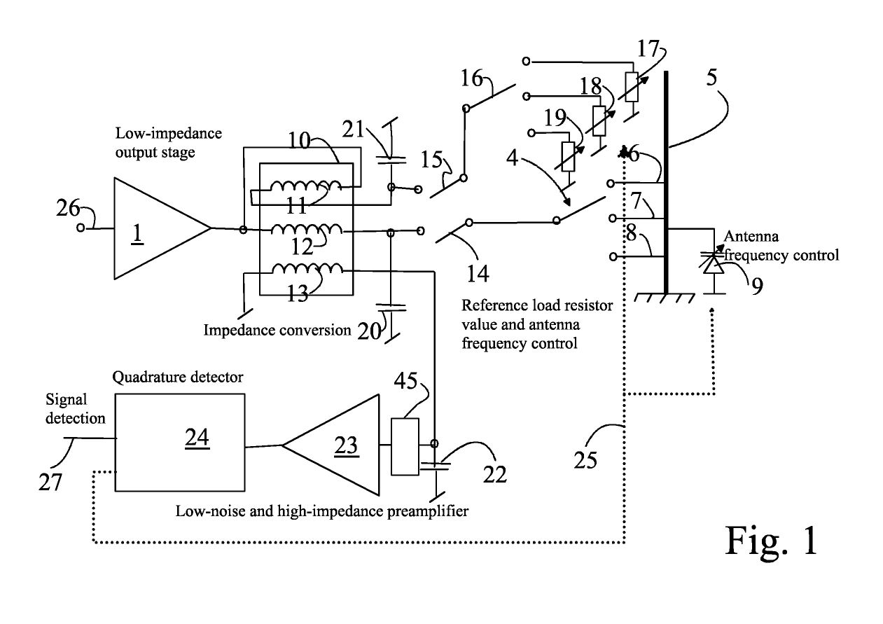

FIG. 1 shows an RFID reader according to the invention.

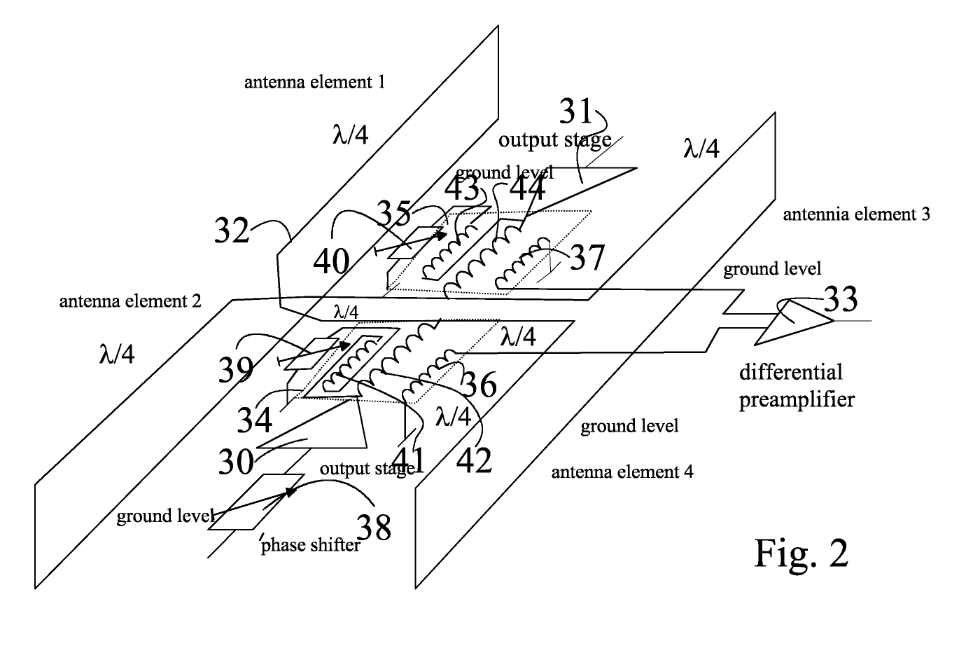

FIG. 2 shows a second RFID reader according to the invention.

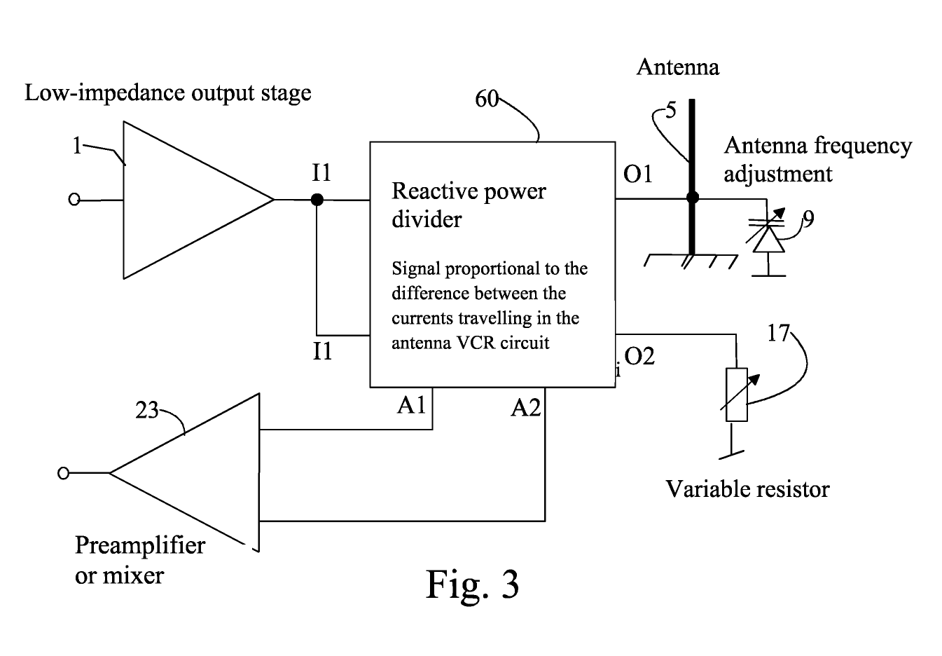

FIG. 3 shows a third RFID reader according to the invention.

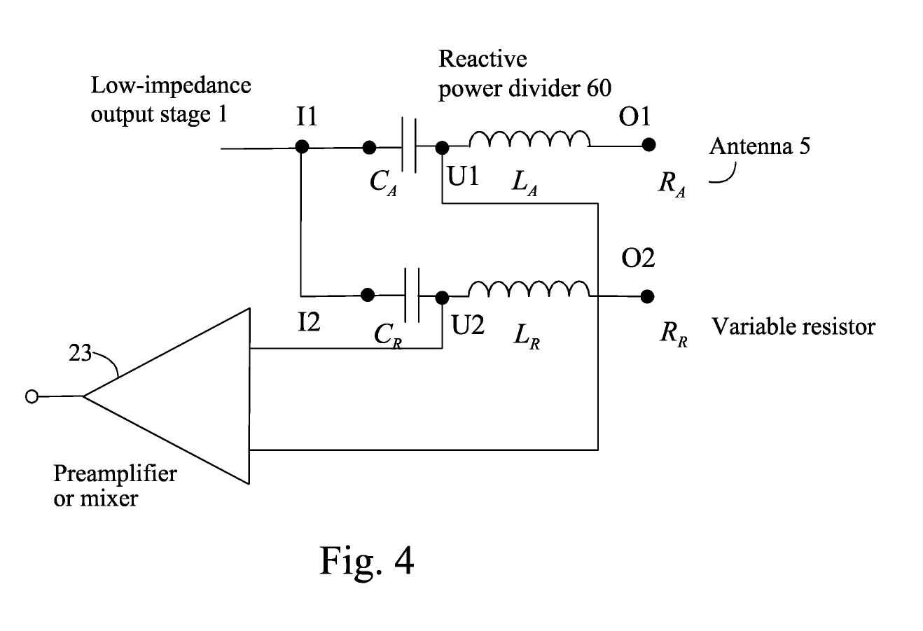

FIG. 4 shows a fourth RFID reader according to the invention.

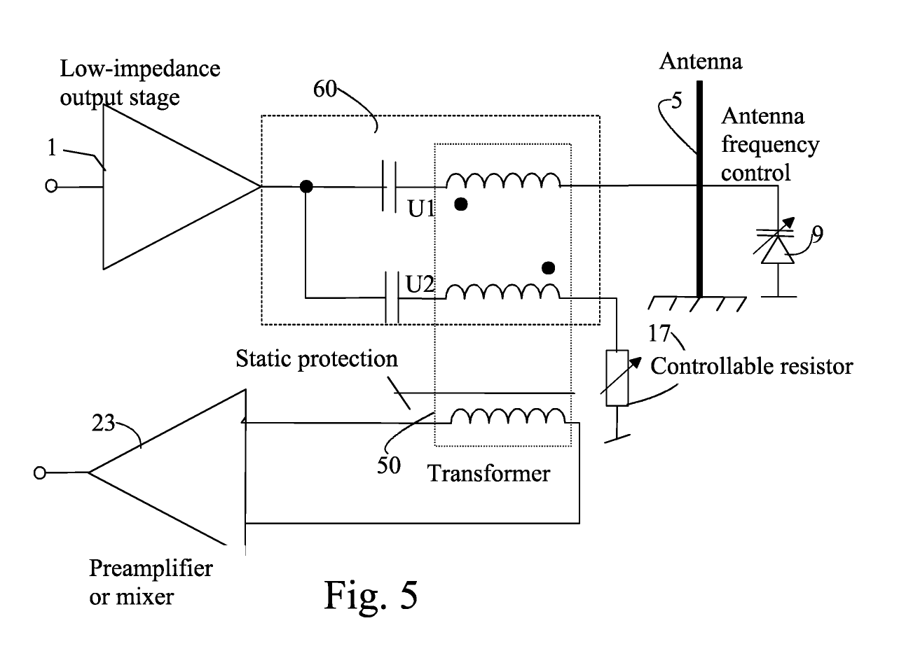

FIG. 5 shows a fifth RFID reader according to the invention.

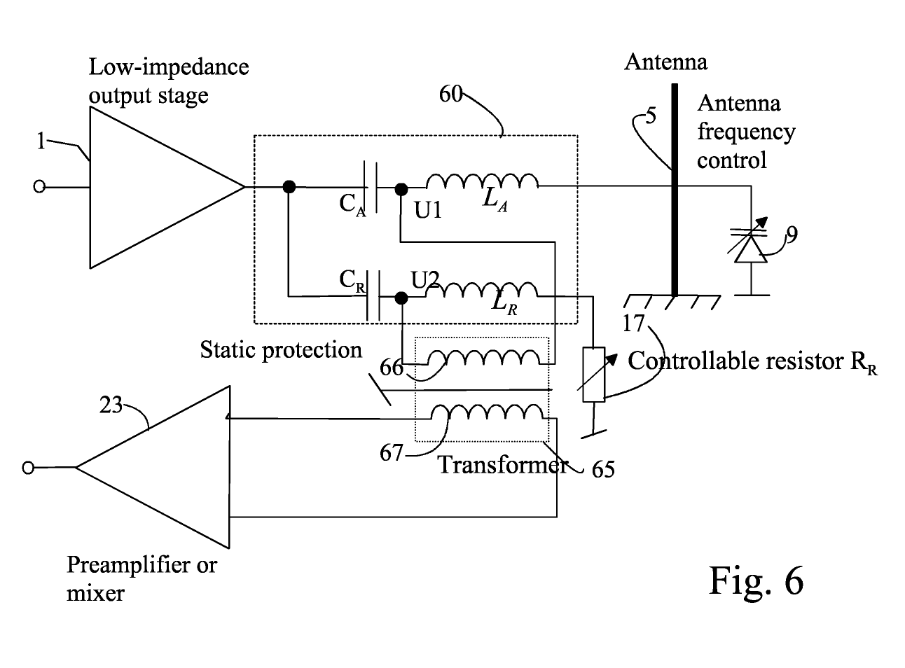

FIG. 6 shows a sixth RFID reader according to the invention.

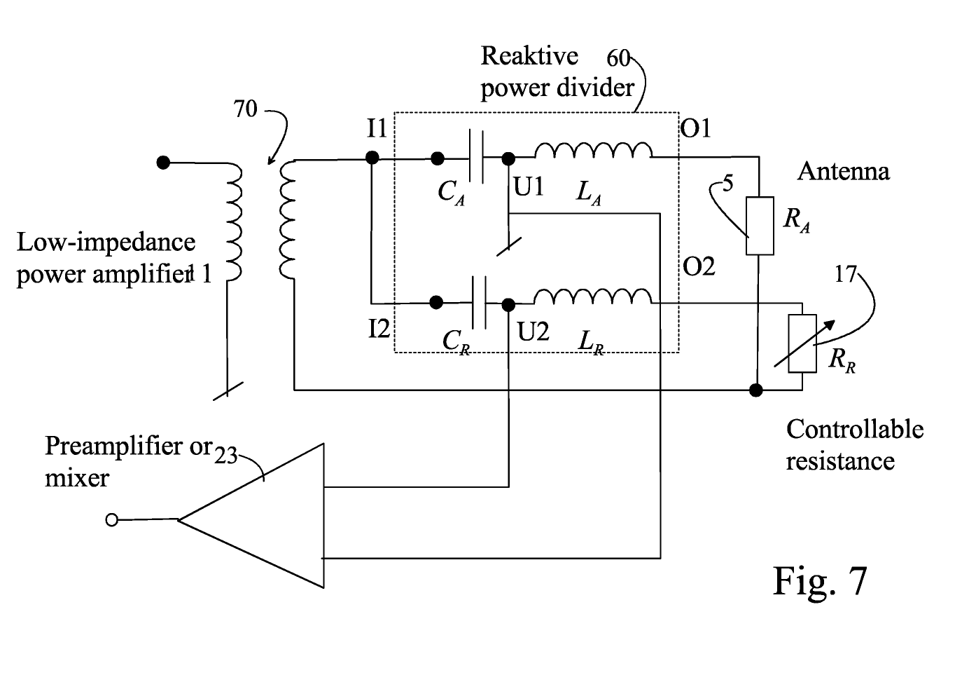

FIG. 7 shows a seventh RFID reader according to the invention.

FIG. 8 shows an eighth RFID reader according to the invention.

In the description of the preferred embodiments of the invention relating to FIGS. 1-8, the following terminology is used in connection with the reference numbers:
1 output stage
4 antenna switch
5 antenna
9 varactor
10 transformer
11 second coil of transformer
12 first coil of transformer
13 third coil of transformer (detector coil)
14 power-control switch
15 impedance switch
16 impedance selector switch
17 variable impedance
18 variable impedance
19 variable impedance
20 capacitor
21 capacitor
22 capacitor
23 preamplifier
24 quadrature detector
25 control line
26 input
27 signal detection
30 output stage
31 output stage
32 antenna element
33 differential amplifier
34 current transformer
35 current transformer
36 third coil
37 third coil
38 phase shifter
39 reference load
40 reference load
41 second coil
42 first coil
43 second coil
44 first coil
45 variable filter
50 transformer
60 reactive power divider
65 transformer
66 primary coil
67 secondary coil
70 input transformer

The present invention discloses a method, in one preferred embodiment of which a very low-impedance amplifier, which is directly connected to the antenna 5, is used as the output stage 1. The impedance level of the antenna is selected in such a way that the outgoing power at the radio frequency is appropriate. If a long reading distance is desired, it is possible, for example, in Europe to use the greatest permitted directional transmission power of 2 W at the 865-MHz frequency. In addition, the antenna is tuned, for example, using a varactor, in such a way that the impedance is always real, in order to optimize efficiency. By means of this arrangement, it is possible to significantly improve the efficiency of the output stage. The transmission power can be adjusted with the aid of a switch 4, by connecting the antenna 5 from different connection points 6, 7, and 8.

As such, the arrangement described above does not permit the use of the reflection technique to detect the modulation created by the RFID. Because the antenna 5 is rigidly connected to the output stage 1, the voltage over it does not depend on reflection.

The modulation created by the RFID can be detected by means of the arrangement according to FIG. 1. The transformer 10 of the figure comprises at least three coils 11, 12, and 13. The current going to the antenna 5 travels through the first coil 12. Current to the reference load 17, 18, or 19 travels through the second coil 11, in such a way that it compensates as precisely as possible for the magnetic field induced by the current going to the antenna 5. The second coil 11 is typically connected in such a way that its current induces a magnetic field in the opposite direction and of the same magnitude as the magnetic field induced by the first coil 12. In practice, this is implemented by placing the first coil 12 parallel to the second coil 11, in which case the connection or winding of the coils 11 and 12 will be opposite to each other, in order to implement the condition described above. The third coil 13 connects to a preamplifier 23, either directly or through a preamplifier, filter 45, or other necessary components. Here, the term connects refers to the fact that the signal of the third coil 13 connects to the preamplifier 23 either directly, or indirectly according to FIG. 1. Thus, the coil 12 is used to measure the current or voltage coming from the output stage 1 depending on the impedance of the preamplifier 23, so that the effective impedance of the antenna 5 can be measured. The figure shows the current-measurement alternative. Due to its manner of operation, in typical embodiments of the invention the transformer 10 can be referred to as a current transformer. Because in the method the antenna 5 is kept real the whole time by the varactor 9 despite reflections, the voltage from the output stage 1 of the same transformer 10 can be connected simply to a real variable impedance 17, 18, and 19 and thus compensate for the voltage created in the preamplifier 23 by the current of the output stage 1. If the reference resistor 17, 18, 19 is variable, it is also possible to compensate for the effect of reflections on the current going to the antenna 5. If the reference resistor is fixed, or if the time constants of the regulators are selected to be slow (e.g., less than 10 kHz), only the modulation created by the RFID circuits will create a signal in the preamplifier 23. This arrangement is intended to prevent the saturation of the preamplifier 23. The variable real impedance 17, 18, 19 can be implemented, for example, using PIN diodes or an FET. By utilizing the conversion ratios of the transformer 10, the impedance of the reference load 17, 18, or 19 can be kept high, so that it does not significantly increase the power consumption of the system. In principle, the pre-stage 23 can be connected to the system in two ways. If the third coil (detector coil) 13 is strongly connected to the two other coils 11 and 12, it will be advantageous to make the preamplifier 13 high-impedance. The voltage induced by the third coil 13 will then be proportional to the derivative of the magnetic field induced by the difference between the currents going to the antenna 5 and the reference resistor 17, 18, and 19. The other alternative is to exploit feedback to make the input impedance of the preamplifier 23 extremely small, in which case the voltage in the output of the amplifier 23 will be directly proportional to the magnetic field. As such, there is no great difference between the methods, but the most important aspect is that the invention is at its most advantageous when the preamplifier 23 is either high or low-impedance. Thus, the invention will come as a surprising solution to one skilled in the art, who would typically select 50 Ohm as the input impedance of the preamplifier, which is not in the optimal range according to the invention. By optimizing the number of windings of the transformer 10, the impedance seen by the preamplifier 23 can also be affected, thus taking care of the noise adaptation. In the example in question, the noise adaptation changes if the power fed to the antenna 5 is changed. If it is wished to optimize the noise adaption in all situations, the number of windings of the induction coil should be changed, or an impedance transformer placed between the detector coil 13 and the preamplifier 23. If it is intended to keep the preamplifier 23 either high-impedance or alternatively low-impedance, it is best to integrate the preamplifier 23 very close to the transformer 10. A very advantageous solution is to use capacitance to tune the inductance of the detector coil 13, and connect a FET-type high-impedance preamplifier directly close to the detector coil 13. A variable filter 45 (if the same electronics are also being used in a GSM telephone), such as an LC filter, can be placed, for example, after the FET acting as the preamplifier, and after it the second amplifier stage 23. If the FET amplifier is further feedback-connected so that its impedance increases, a highly linear preamplifier will be created. This is advantageous, because particularly a portable RFID reader demands great dynamics, not only because of reflections, but also because of the signal caused by other readers.

After the preamplifier 23, the signal is detected, for example, by a quadrature detector 24, in which both the real 25 and imaginary 27 components of the signal are detected. In a preferred embodiment of the invention, the real output 25 of the detector 24 is used as feedback to control both the artificial loads 17-19 and the varactor 9, in order to implement the frequency control of the antenna.

If the impedance of the preamplifier 23 is large, the voltage over the coil 13 is measured and the imaginary component of the detector 24 is used to control the artificial loads. Always depending on the impedance of the preamplifier 23, forms in between these cases are also possible.

If the method is used with a fixed power, the system can be further simplified by removing the switches 14 and 4 and feeding the signal directly to the antenna 5, so that the power always equals the maximum power.

It should be noted that, in the solution of FIG. 1, the first switches 15 and 16 after the transformer 10 can be unnecessary when operating at a single power level, if it is used purely as an RFID reader. They will be required, if the same electronics are used as both a UHF-RFID reader and as a GSM telephone. A second alternative is to combine Bluetooth (or WLAN) and a microwave-RFID reader in the electronics in question. The second switches 14 and 4 are only necessary if it is wished to adjust the power level.

It is often wished to combine, for example, a GSM telephone with portable RFID readers. In this solution, a UHF-RFID is obtained in the GSM telephone simply by adding to it a transformer 10 and PIN diodes 17-19 integrated in a circuit board. The additional cost associated with the components will remain less than [symbol] 1,-.

The first coil 12 of the current transformer 10 shown can also be part of the antenna itself, in which case power savings can be achieved.

FIG. 2 shows a solution suitable for a fixed reader, in which two output stages 30 and 31 are used to feed an antenna element 32. As in FIG. 1, the third coils 36 and 37 of the transformers 34 and 35 are connected to the input of a differential amplifier 33. A phase shifter 38 is arranged in the input of the second output stage 30, in order to adjust the direction of the antenna. Due to the two output stages 30 and 31 a possibility to feed double power to the antenna 32 is achieved. The branch of the second coil 41, 43 of the transformers 34 and 35 is connected to the reference load 39 and 40 in accordance with FIG. 1. The second coils 41 and 43 of the transformer 34 are connected in such a way that the current travelling in the coil 41 compensates for the magnetic field induced by the current travelling through the coil 42, so that the coil 36 connected to the preamplifier 33 sees only the signal returning from the RFID tag. Correspondingly, the current travelling in the coil 43 compensates for the magnetic field induced by the current travelling through the coil 44.

The antenna 5 or 32 or the antenna group can be connected to the output stage and the circuits related to it, either directly galvanically, or alternatively through a suitable transfer path, in which case galvanic contact will not be necessary.

The transformer's 10 first coil 12, through which the current of the output stage 1 goes to the antenna 5, can also be replaced by part of the antenna, or it can form part of the antenna. The magnetic field induced by the current travelling in the antenna will then be picked up and compensated by the coil 11, when it connects to the third coil 13 going to the preamplifier 23.

The adjustment and compensation of the frequency of the antenna is typically made continuously in the frequency level up to the frequencies at which modulation starts. In practice, 1 kHz-10 kHz is the maximum compensation bandwidth. The essential feature in this embodiment is that the compensation is extremely fast and reflection cannot arise faster.

A problem with UHF frequencies is that, in different parts of the world, there are frequencies from 865 MHz up to 950 MHz. It is difficult to make a small antenna that covers all of the frequencies well and, in addition, with good efficiency. In this solution according to the invention, the antenna is typically naturally narrowband and adjustable, which permits a solution with good properties, operating over a wide frequency range. In addition, places for capacitors can be attached to the antenna. By connecting a capacitor to a suitable location, a product can be preselected, for example, for Asian markets, without a new antenna.

Besides a PIN diode or an FET, in principle any resistor whatever, controlled by voltage, can be used to compensate the real component of the antenna. The transformer creates a situation, in which only a small portion of the power can be led to the variable resistor, this being a great advantage, as it is very difficult to make a variable resistor with a large dynamic, if watts of power are led to it. Such a power component is expensive and cannot be integrated inside an IC.

With the aid of one embodiment of the invention, the variable resistor can be easily implemented as even low power, as long as sufficiently large number of windings is formed in the coil of the reference resistor. However, with a large number of windings it may be necessary to tune to coil, for example, with the aid of a capacitor.

Instead of a varactor, it is possible to use any variable reactance whatever: a varactor, a para-electrical control capacitor, switch elements and fixed capacitors, etc.

With the aid of the invention, in addition to the identity and information content of the object (RFID tag) being measured from the outputs 27 and 25 of the detector 24, it is also possible to obtain the distance of the object, and its movement, such as whether it is approaching or receding from the reader.

Handheld-reader markets are growing very briskly and readers are being integrated in mobile telephones. Particularly in South Korea the aim is for UHF RFID to handle both logistics applications and so-called TouchMe applications (ticketing, payments, etc.).

A preferred embodiment of the present invention presents a circuit and method, in which a very low-impedance amplifier is used as the output stage, which is connected directly to the antenna through a series-resonance circuit. The antenna's impedance level is selected to achieve appropriate radiating power. In addition, the antenna is tuned, for example, by means of a varactor, in such a way that the impedance of the antenna is always real, to optimize efficiency. The use of this arrangement permits a significant improvement in the efficiency of the output stage. The tuning of the antenna also partly eliminates, for example, the effects of the hand and reflections on the reading of an RFID tag. A problem is that, as such, this arrangement does not permit the use of the reflection technique to detect the modulation created by the RFID. As the antenna is rigidly connected to the output stage, the voltage over it depends only partly on reflection. However, we can make the arrangement according to FIG. 3, in which we lead the current to two branches, one going to the antenna 5, and the other to the variable resistor 17. If the branches are formed of reactive circuits, we will avoid power consumption. In addition, if the current going to the variable resistor 17 is n times less than the current going to the antenna 5, the lost power will only be part of the total power in n. In addition, the reactive elements should be dimensioned so that two node points, with a voltage difference of zero between them, are to be found inside them. The bridge is balanced by setting the antenna 5 to be real, for example, by means of a varactor 6 and a variable resistor 17, so that the ratio of the currents is n. In an ideal situation, the ratio of the real components of the antenna 5 and the variable resistor 17 is n. The real component of the antenna 5 should be selected in such a way that the output stage 1 can be run to saturation, or we can use a switch-type output stage, in order to minimize power losses. Because the antenna 5 can be narrowband, we will not create excessive harmonics. The adjustment is made either so slowly that we do not damp the modulation (to less than 100 kHz), or else we adjust the bridge to equilibrium before transmitting the modulation to the RFID tag. During the reading of the RFID, which typically lasts less than 10 ms, we do not implement adjustment, so that the modulation will be detected.

A simple solution is to place a capacitance and inductance series connection between the branches. The circuit is shown in FIG. 4. If the ratio of the capacitances is n(C_{R}/C_{A}), the voltage difference between the points U1 and U2 will be zero. The difference can be taken directly to a differential amplifier. If the voltage of the output stage 1 is high, the common-mode voltage will become so high that we will exceed the duration of the common-mode potential of the amplifier. However, if the capacitances are selected to be sufficiently great and correspondingly the coils to be small, the common-mode potential will remain small. If the maximum voltage of the output stage is 3 V, and we use a 5-V differential amplifier, the circuit according to FIG. 4 will be possible by selecting the reactances of the series-resonance circuit suitably. In practice, this means that the value of the reactances of the series resonance will be of the same order as, or smaller than the corresponding loss resistance of the branch. This means that the figure of merit of the reactive branches will be kept as small as possible.

A second simple solution is to use a transformer, as shown in FIG. 5. If the ratio of the numbers of windings of the transformer 50 is n, the transformer's flux is zero. In a state of equilibrium, the voltage going to the preamplifier 23 is zero. In practice, we may have to place a protective ground in the transformer 50, to eliminate the common-mode voltage. In addition, it is best to earth in the middle the transformer 50 connected to the preamplifier 23. The transformer 50 should be dimensioned in such a way that the inductance of the branch going to the antenna 5 will be reasonably small, so that the inductance of the single-winding coil will remain within the order of magnitude of the impedance of the real component of the antenna. In other words, if the impedance of the antenna 5 is 10 Ohm, the AL value of the transformer would be only about 1 nH in the UHF range. The inductance of transformers is typically greater than this, so that it is advantageous to make an air-core coil, or to make the core of the transformer of a ferrite rod or toroid, which is cut with an air gap, in order to reduce the inductance. An air-core coil can be made directly onto a multi-layer circuit board. A small inductance will more easily permit a wide control band. The coil going to the preamplifier or mixer 23 should be selected in such a way that the amplifier operates close to the noise optimum. Typically, this is the same as the number of windings of the coil going to the variable resistor (e.g., 4).

A sixth circuit is shown in FIG. 6. In it the difference in potential between the points U1 and U2 is connected through the transformer 65 to the preamplifier 23. The reactive power divider 60 comprises two branches. In the one, the antenna branch, is the series connection of the coil L_{A} and the capacitor C_{A}, and in the second, the resistor branch, the series connection of the coil L_{R} and the capacitor C_{R} is in series with the variable resistor 17. It is best to select the number of windings in the transformer 65 in such a way that the number of both the primary 66 and secondary 67 windings is as small as possible, but nevertheless large enough for the figure of merit of the resonance of the coil not to narrow the band too much. A good rule of thumb is to dimension it in such a way that the inductance level is the same as the impedance of the variable resistor. Thus, if R_{R} is 40 Ohm, a suitable inductance value in the UHF range will be about 6 nH. In the case of the transformer 65 too, it may be necessary to isolate the coils from each other by protection.

A fourth circuit is shown is FIG. 7. In this case, the input is made to float with the aid of an input transformer 70, when the centre point U1 of the second reactive branch can be earthed and thus the common-mode potential can be reset. If necessary, the transformer 70 can also be used to raise or lower the impedance, in which case the input point of the antenna need not be altered for different power levels. A weakness in this circuit is a slightly greater reduction of the power efficiency, which, however, in the case of a single-transistor output stage is void, as the operating voltage can be brought through the primary winding of the transformer. Another weakness relates to the fact that the antenna 5 is floating and creates a common-mode potential against the ground, which in some situations can be bad. On the other hand, in the case of an inductive loop antenna, the common-mode potential creates radiation, which in some situations improves the radiation efficiency of the antenna.

The reactive power divider 60 can also be replaced with a so-called four-port hybrid, in which the power of the output stage is divided equally between two ports. If the impedance of both ports is 50 Ohm, the power coming to the fourth port is zero and thus the bridge is in equilibrium. Thus, in this special situation we can replace both the transformer and the power divider with a hybrid, which is a very wideband, reasonably priced commercial component. In all other respects, the circuit is the same.

In the present invention, the frequency of the antenna is controlled, for example, using a varactor and only its real component is regulated in a variable resistor. In principle, we can make a solution, in which the control components are a) both in the antenna port, b) both in the so-called resistor port, or c) the real component of the antenna is adjusted as desired and there is compensation of the imaginary component in the ‘variable-resistor’ port. It is easy to show that the manner shown here leads to the best result. However, there may be situations in which it is not wished to adjust the antenna port, but instead it is wished to make the adaptation in the ‘variable resistor’ port. This will be the case if a 50-Ohm solution is used in the connection of the antenna and it is wished to utilize commercial non-adaptive antennae.

FIG. 8 shows a circuit, in which the circuit can be optimized for different power levels. We can adjust the power level with the aid of switches, so that the low-impedance output stage can operate in saturation or in switch mode. Saturation or switch mode results in the output voltage of the output state being constant and the power is adjusted by altering the load. Usually, RFID devices operate mainly at maximum power, so that the circuit in question should be utilized only in special cases. For example, in a situation in which a long reading distance (e.g., 3-4 m) is only reasonably seldom needed in a handheld reader, but that is mostly used at a lower power when the reading distance is, for example, 1 m.

It is advantageous to make the antenna 5 real, whereby we can regulate the series resonance associated with the circuit independently of the antenna. Of course, the antenna can be left either capacitive or inductive while the circuit is nevertheless made to resonate. This also applies to a variable resistor. If the inductance is in series with the variable resistor, and in addition there is capacitance over the resistor, it will be difficult to keep the circuit real at all resistance values. In practice, this means that the variable resistor should contain as few parasitic components as possible. The variable resistor can be made using a PIN diode or a FET-type transistor. In principle, a bipolar transistor can also be used. Successful adjustment of the antenna will be easiest either by using a varactor that is internally linearized, or by placing two varactors in series. The varactor can be connected either to the high-tension part of the antenna, or directly over the input point. If the adjustment range requires, the adjustment range of the varactor can be widened using a switch and a fixed capacitance. In principle, any type of antenna whatever can be used with the circuit. However, it is advantageous if the input impedance in the antenna can be easily adjusted. For example, in PIFA-type antennae it is easily to alter the input impedance by altering the location of the feed point.

The output stage is preferably switching type, in which two output transistors switch the operating voltage and earth alternately to the inputs I1 and I2. Another way is to connect the voltage to earth using a transistor and lead the operating voltage to the circuit through a coil. However, such a circuit is very difficult to dimension, because the voltage induced in the coil must under no circumstances create a negative voltage over the transistor, as in that case the diode in the transistor would lose power. However, the essential feature of the invention is that we obtain the most rectangularly-shaped voltage from a low-impedance output stage, in such a way that the peak value of the rectangle would be as close as possible to the operating voltage. In the UHF range, the efficiency of a highly optimized output stage can be as much as 80%.

The problems of the circuit arise mainly from the fact that the centre points of the series-resonance circuit are loaded really or reactively. Because the impedances of the branches differ, the bridge can easily become unbalanced. On the other hand, the difference of the inputs easily results in a common-mode voltage. This must be eliminated by means of protective earthing. The protective earthing prevents capacitive crosstalk, but loads the centre point of the series resonance capacitively. In practice, this leads to the power going to the impedance transformer and branches no longer being defined simply from the equations U²/R_{A} and U²/R_{R}. On the other hand, the additional capacitance significantly hinders the balancing of the bridge on a broad band. The best way to eliminate this problem is, in the transformer case, to keep the inductances sufficiently low and, in the series-resonance case, the capacitance values sufficiently high.

We have presented a new RFID reader suitable for UHF and microwaves. The circuit is very simple and requires only a few moderately-priced components. It compensates for the connection to the preamplifier of the power going to the antenna. On the other hand, it can be made sufficiently broadband to cover the entire RFID-UHF range. By combining the present UHF solution and VTT's earlier FeMod solution, we can easily combine a UHF RFID reader and GSM/GPRS in such a way that they use the same antenna and a common output stage and pre-stage. This would make it possible to bring a UHF RFID reader cheaply to all mobile telephones. The core of the invention is to combine a low-impedance output stage, a reactive power divider, and an adjustable antenna. The current modulation of the RFID tag can be measured in many different ways.

1. RFID reader, which comprises
a transmitter portion,
a receiver portion, and
an antenna or antenna group connected to these,
wherein
the transmitter portion comprises a reactive power divider, in which there are at least two reactive branches,
one branch for feeding the signal to the antenna, and
a second branch connected in series with a variable resistor.

2. RFID reader according to claim 1, wherein the device comprises in addition capacitors in each reactive branch on the transmitter side of the reactive power divider.

3. RFID reader according to claim 1 or 2, wherein the device comprises in addition a transformer circuit, in which there are at least two coils connecting to the same magnetic field, the first of which is part of the current circuit of the antenna and the second is connected to the preamplifier of the receiver.

4. RFID reader according to claim 1, wherein the antenna is arranged to connect from different connection points of the transmitter or receiver portions.

5. RFID reader according to claim 1, wherein the reference load is electrically adjustable.

6. RFID reader according to claim 1, wherein an electrically adjustable capacitor is connected in parallel to the antenna, in order to tune the antenna to different frequencies.

7. RFID reader according to claim 1, wherein the arrangement includes an electrically controllable switch arranged in connection with the antenna, by means of which the connection point of the antenna can be adjusted.

8. RFID reader according to claim 1, wherein the number of windings of the second coil connected to the reference resistor is selected to be large, so that the power going to the reference resistor can be kept small.

9. Method in an RFID reader, in which method
electromagnetic radiation is sent by the transmitter portion,
the signal received by the receiver portion from RFID tags is received with the aid of an antenna or antenna group,
wherein
in the transmitter portion there is a reactive power divider, in which there are at least two reactive branches, of which
by means of one branch the signal is fed to the antenna, and
by means of the second branch the signal is fed to a variable resistor.

10. Method according to claim 9, wherein, in addition, capacitors are connected to the device, to each reactive branch on the transmitter side of the reactive power divider.

11. Method claim 9 or 10, wherein the method a transformer circuit is used in addition, in which there are at least two coils connecting to the same magnetic field, the first of which is part of the current circuit of the antenna and the second is connected to the preamplifier of the receiver.

12. Method according to claim 9, wherein the antenna is arranged to connect to the transmitter or receiver portions from different connection points.

13. Method according to claim 9, wherein the reference load is electrically adjustable.

14. Method according to claim 9, wherein an electrically adjustable capacitor is connected in parallel to the antenna, in order to tune the antenna to different frequencies.

15. Method according to claim 9, wherein the arrangement comprises an electrically controllable switch arranged in connection with the antenna, by means of which the connection point of the antenna can be adjusted.

16. Method according to claim 9, wherein the number of windings of the second coil connected to the reference resistor is selected to be large, so that the power going to the reference resistor can be kept small.
